(19) United States
(12) Patent Application Publication
(10) Pub. No.: US 2005/0075890 A1
(43) Pub. Date: Apr. 7, 2005

(54) Method, device and product for determining entertainment elements and producing entertainment

(76) Inventors: Anthony Jimmy Pimenta, Mississauga (CA); Terrence William Cottrell, Kitchener (CA); Michale Raske, Toronto (CA)

Correspondence Address: OGILVY RENAULT, 1981 MCGILL COLLEGE AVENUE, SUITE 1600, MONTREAL, QC, H3A2Y3, CA

(21) Appl. No.: 10/674,816

(22) Filed: Oct. 1, 2003

(51) Int. Cl. G06F 17/60

(52) U.S. Cl. 705/1

(57) ABSTRACT

The invention provides a method for producing an entertainment product that allows members of the public to collectively make decisions that are traditionally made by the producers of the entertainment and to submit themselves as participants in the production of the entertainment. The method comprises the steps of: designating a predetermined number of elements, associated with said entertainment product, that are open for application; registering a plurality of producers upon receiving producer applications that are open to the public; registering a plurality of contestants for each said element upon receiving contestant applications that are open to the public; registering producer input regarding contestants; determining at least one winner for each said element based at least partially on said producer input; and producing the entertainment product in accordance with the winners.

This invention relates to methods of producing entertainment and more specifically to methods of producing entertainment in accordance with the results of a voting or rating process for various entertainment elements, and devices, products and methods relating thereto.

### BACKGROUND OF THE INVENTION

The production of entertainment and media often involves contributions from numerous individuals, particularly for sophisticated projects. For example, a composer, singer, musicians, conductor, and editor may all be necessary to produce a classical music recording. Similarly, the production of movies and feature films commonly involves a screenwriter, director, editor, cinematographer, actors, costume and set designers and various other technical and creative people.

Once a screenplay has been given approval for production (i.e. the project has been “greenlighted”), it is the director's vision that shapes the look and feel of a film. The director transforms the words of a script into images on the screen with the help of the actors, cinematographer, designers and technical staff. The director is the creative force that pulls a film together.

Just as the director often makes the creative decisions within a film, the producer often holds the decision making authority as to which script to develop, which director to hire, which screenplay to film and who will be cast. The producer often represents the financial support for a feature film. Traditional decisions that are made by a producer are therefore often out of reach of the normal public. Similarly, employment as the various creative and technical people associated with making a feature film, such as the screenwriter, director, editor, cinematographer, actors, costume and set designers are also difficult fields to break into and thus often out of reach for individuals aspiring to work in feature films.

However, members of the general public are almost always the end-consumer of an entertainment product. Thus, entertainment products that are developed with the preferences of these target consumers in mind, and are more accessible to the general public, will have marketing advantages and greater appeal and success.

It is known in the art to hold competitions whereby script/screenwriters submit scripts for evaluation. The winner of these competitions is often entitled to a cash prize. In some instances, the prize includes an introduction to a production company and film executives. In a few instances, the prize is production of the winning script into a feature film. However, the decision making as to who wins the competition is in the hands of a pre-selected judging panel. Furthermore, subsequent production decisions, such as director, cast and other creative and technical personnel are in the hands of the film's producers.

It is also known in the art to poll a consumer base to determine a consumer preference with respect to a certain product. In particular, U.S. Patent Publication No. 2003/0014277 discloses a process for developing entertainment projects that captures the preference of consumers. Consumer preferences are determined by the staging of a web based poll of registered qualified voters that are sponsored by the producers of the project. Voters are presented with a set of pre-selected alternatives that will alter the course of production for an entertainment project. Again, although the project will be altered based on voter preferences, there is limited control of the project given to the public since the project itself, project alternatives and the voter population are pre-selected by the producers.

There is a need to develop improved processes and methods for producing entertainment projects that provide greater access to the public and thus have distinct marketing appeal.

### SUMMARY OF THE INVENTION

This invention provides a method for producing an entertainment product that provides greater access to members of the public.

The invention further provides a method for producing an entertainment product that allows members of the public to collectively make decisions that are traditionally made by the producers of the entertainment and to submit themselves as participants in the production of the entertainment.

According to one broad aspect of the invention, a method of producing an entertainment product is provided comprising the steps of: designating a predetermined number of elements, associated with said entertainment product, that are open for application; registering a plurality of producers upon receiving producer applications that are open to the public; registering a plurality of contestants for each said element upon receiving contestant applications that are open to the public; registering producer input regarding contestants; determining at least one winner for each said element based at least partially on said producer input; and producing the entertainment product in accordance with the winners.

According to another aspect of the invention, a method of determining the identity of elements to be used in producing an entertainment product is provided, comprising the steps of: designating a predetermined number of elements, associated with said entertainment product, that are open for application; registering a plurality of producers upon receiving producer applications that are open to the public; registering a plurality of contestants for each said element upon receiving contestant applications that are open to the public; registering producer input regarding contestants; and determining at least one winner for each said element based at least partially on said producer input wherein each said winner of a said element represents the identity of said element.

According to another aspect of the invention, a computer program product is provided, comprising a memory having computer-readable code embodied therein for determining the identity of elements to be used in producing an entertainment product comprising: code means for designating a predetermined number of elements, associated with said entertainment product, that are open for application; code means for registering a plurality of producers upon receiving producer applications that are open to the public; code means for registering a plurality of contestants for each said element upon receiving contestant applications that are open to the public; code means for registering producer input regarding contestants; and code means for determining at least one winner for each said element based at least partially on said producer input wherein each said winner of a said element represents the identity of said element.

One entertainment product is a feature film.

One feature of the present invention is that applications to become registered, either as producers (referred to as “IM Producers” where the entertainment product is a film) and/or contestants, are at least partially open to the public. This allows for numerous advantages.

One advantage of the present invention is that it gives persons who aspire to work in the field of a particular entertainment the opportunity to submit themselves as contestants and to potentially win a role in production of the entertainment based on the preferences of other members of the public and not on industry executives.

A further advantage is that it offers other members of the public the opportunity to participate in the production of an entertainment product. Input from members of the public will ultimately dictate the elements that will participate or be included in the production of the project. This is particularly attractive for people who are fans of that entertainment product. For example, it would give fans of film the opportunity to actually participate in the decisions normally made by the producer such as which script to produce, casting and which director to use.

A further advantage is that by allowing members of the public to provide input into the entertainment product, a market has already been created, as participants will be more likely to consume the product having had some part in its production.

A further advantage is that giving aspiring workers a chance to break into a particular entertainment industry will generate positive marketing.

### BRIEF DESCRIPTION OF THE DRAWINGS

These and other features of the preferred embodiments of the invention will become more apparent in the following detailed description in which reference is made to the appended drawings wherein:

FIG. 1 is a flow chart showing method steps according to one broad aspect of the invention;

FIG. 2 is a flow chart showing method steps for registering members;

FIG. 3 is a flow chart showing method steps for member sign-on;

FIG. 4 is a flow chart showing method steps for reviewing portfolios by IM Producers;

FIG. 5 is a flow chart showing method steps for determining winners;

FIG. 6 is a flow chart showing method steps for final voting by the IM Producers;

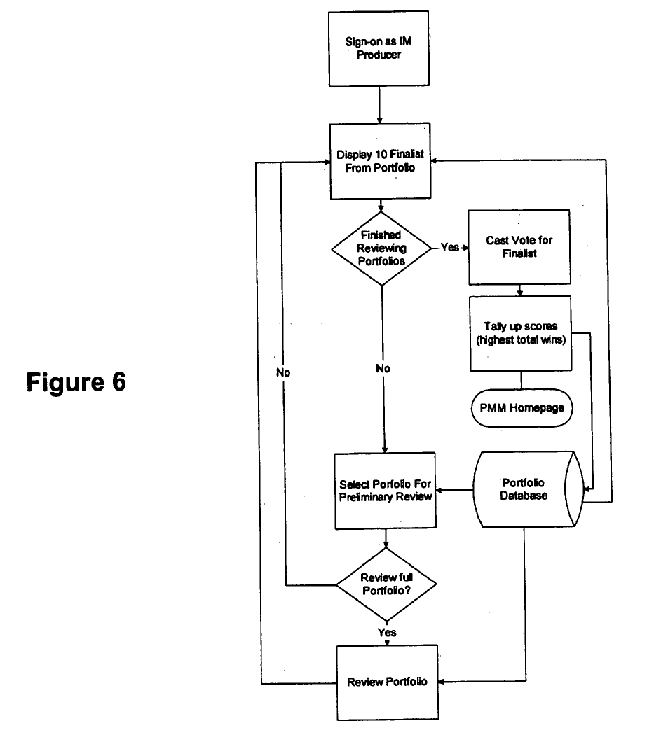

FIG. 7 is a flow chart showing method steps for announcing winners;

FIG. 8 is a screenshot of the home and start page of a web based interface;

FIG. 9 is a screenshot of the web based interface for a membership application;

FIG. 10 is a screenshot of the web base interface for selecting a membership type;

FIG. 11 is a screenshot of the web base interface for agreeing to the rules and regulations;

FIG. 12 is a screenshot of the web base interface for checking out and finalizing membership registration;

FIG. 13 is a screenshot of the web base interface for an in-tray;

FIG. 14 is a screenshot of the web base interface for searching portfolios;

FIG. 15 is a screenshot of the web base interface for selecting a script to review out of search results;

FIG. 16 is a screenshot of the web base interface for a portfolio summary;

FIG. 17 is a screenshot of the web base interface for reviewing a portfolio; and

FIG. 18 is a screenshot of the web based interface for rating a portfolio.

### DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and/or processes have not been described or shown in detail in order not to obscure the invention. In the description and drawings, like numerals refer to like structures and/or processes.

In some instances, the methods of the present invention are claimed and described herein as a series of treatment steps. It should be understood that these methods and associated steps may be performed in any logical order. Moreover, the methods may be performed alone, or in conjunction with other procedures before, during or after such methods and steps set forth herein without departing from the scope and spirit of the invention.

It must be noted that as used herein and in the appended claims, the singular forms “a”, “an” and “the” include the plural referents unless the context clearly dictates otherwise. Thus, for example, reference to “a contestant” includes reference to one or more contestants and equivalents thereof known to those skilled in the art, and so forth.

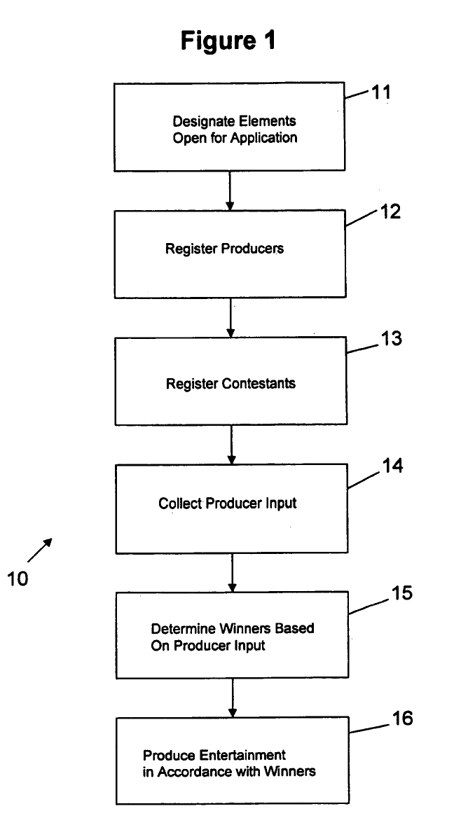

Referring to FIG. 1, one broad aspect of the invention is shown. A method 10 for producing an entertainment product comprises the following steps: designating different entertainment elements, that comprise the entertainment product, as subject to contest and open for application 11; registering members of the public as public producers 12 upon receipt of an application; registering members of the public as contestants 13 for one or more of the entertainment elements upon receipt of an application; collecting public producer input regarding contestants for each entertainment element 14; determining winners based on public producer input 15; and producing the entertainment in accordance with the winners.

A specific embodiment of the invention will now be described in detail with respect to feature films. As used herein, the term “script” and “scriptwriter” are used interchangeably with “screenplay” and “screenwriter”. The methods of the present invention may be effected, at least in part, through a web-based interface.

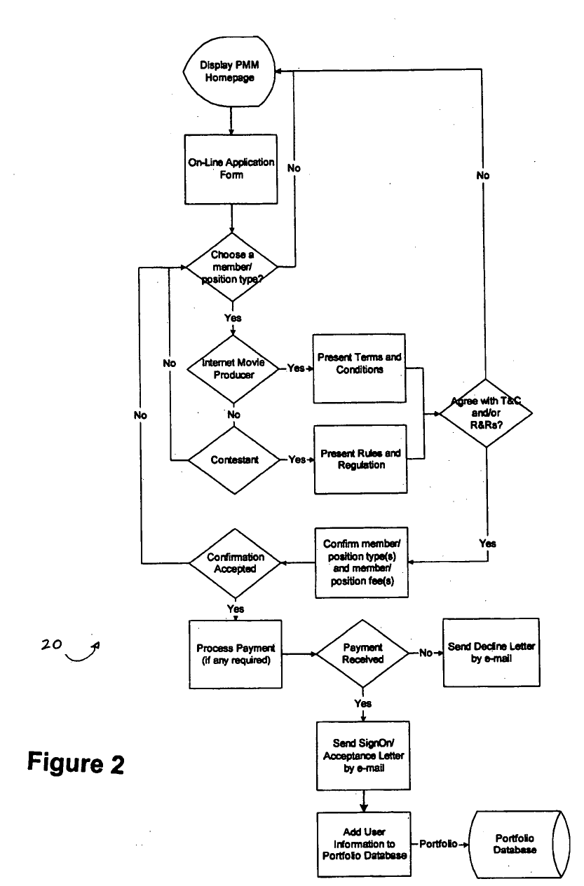

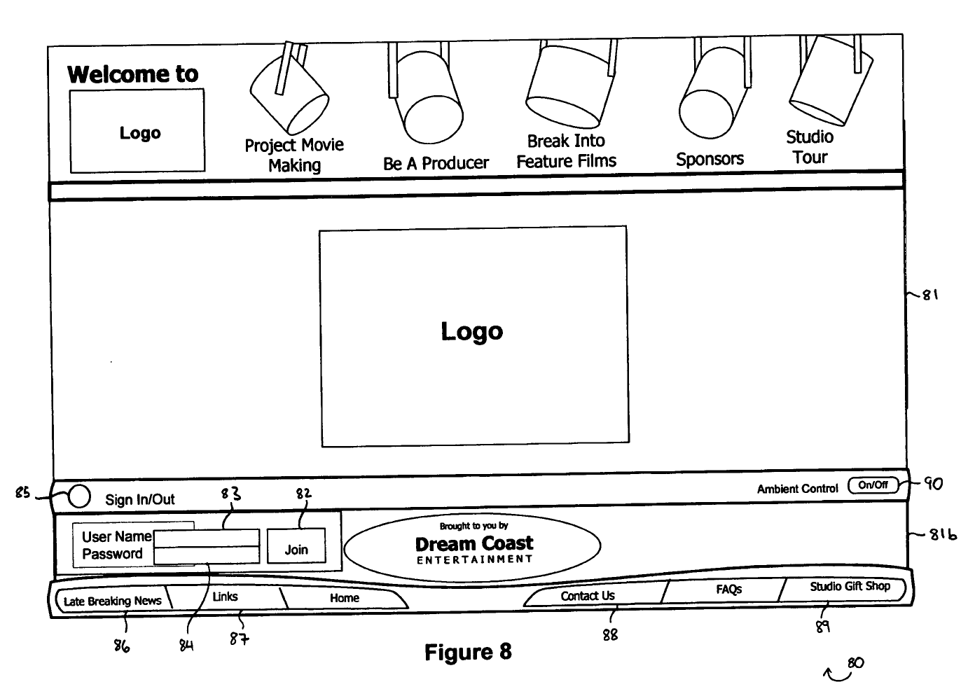

Referring generally to FIG. 2, a preferred method of registering members, as part of a voting population, and/or as contestants is shown at 20. Referring to FIG. 8, a start page 80 for a web-based interface is shown. The start page comprises a display window 81 and a tool bar 81b. The tool bar 81b comprises a join button 82, a user name field 83, a password field 84, a sign in/out button 85, a news button 86, a links button 87, a contact us button 88, a gift shop button 89 and an ambient control button 90. The ambient control button 90 allows a user to turn the background music on or off. The tool bar 81b is preferably present on every page of the web-based interface. In some embodiments of the invention, clicking the sign in/out button, while not signed in, will display a drop down window the name field 83, the password field 84 and the join button 82.

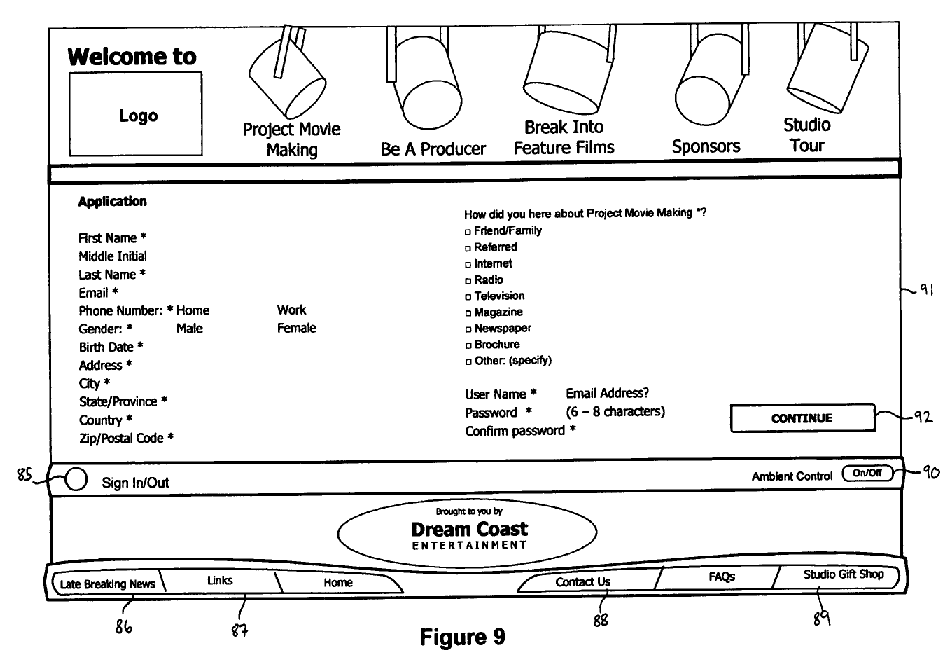

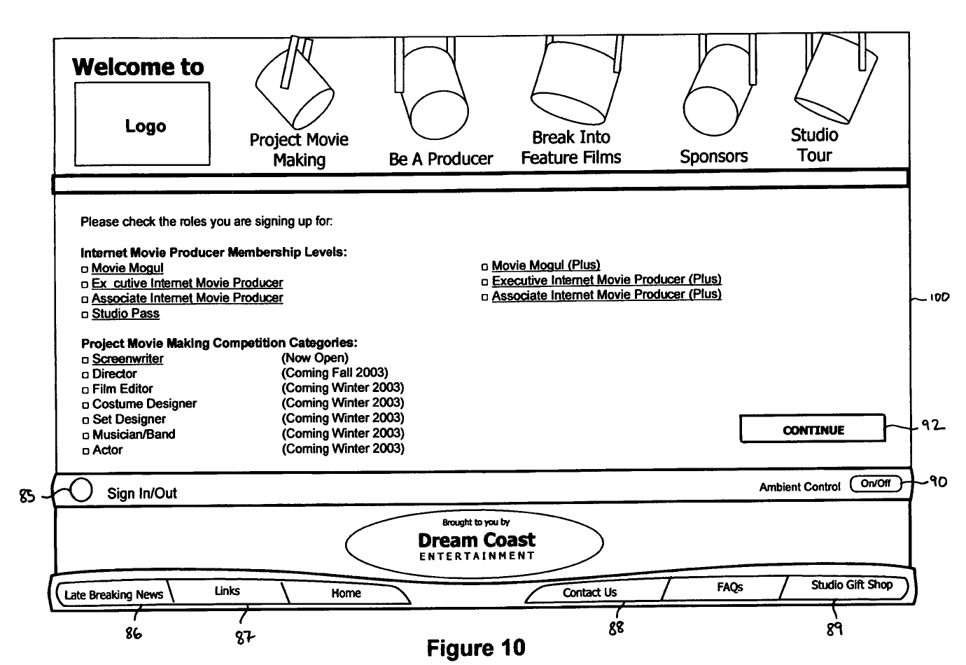

Users are members of the general public and may apply for membership through the web-based interface by clicking on the join button 82. After clicking the join button 82, a user will be presented with an online application form 90 as shown in FIG. 9. The users then fill out basic information about themselves in the fields provided on the application form 91 and click a continue button 92 once they are finished. Referring to FIG. 10, the user will then be presented with a variety of membership categories and users are given the option of choosing one or more member types. There are two broad categories of member accounts, Internet Movie Producers (“IM Producers”) and contestants. Only members that are IM Producers are entitled to vote on entertainment elements. There may be more than one category of IM Producers with varying privileges. There may be any number of categories for contestants, including but not limited to screenwriter, director, film editor, costume designer, set designer, musician/band, actor, key grip, make-up artists and other positions involved in producing a feature film. The user then clicks the continue button 92 once he/she has selected at least one desired membership category,

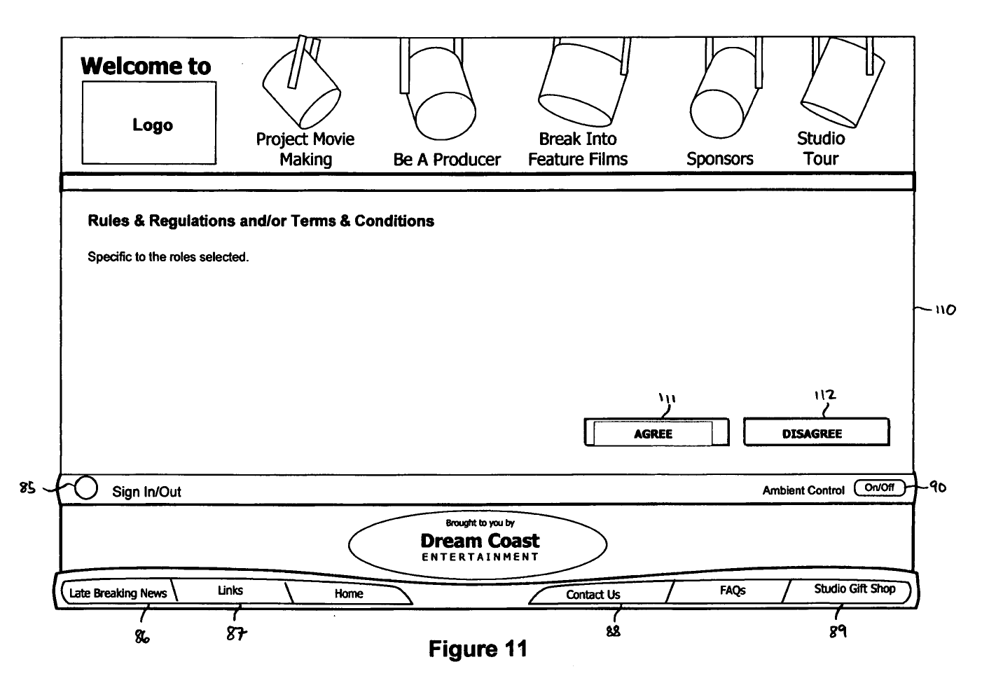

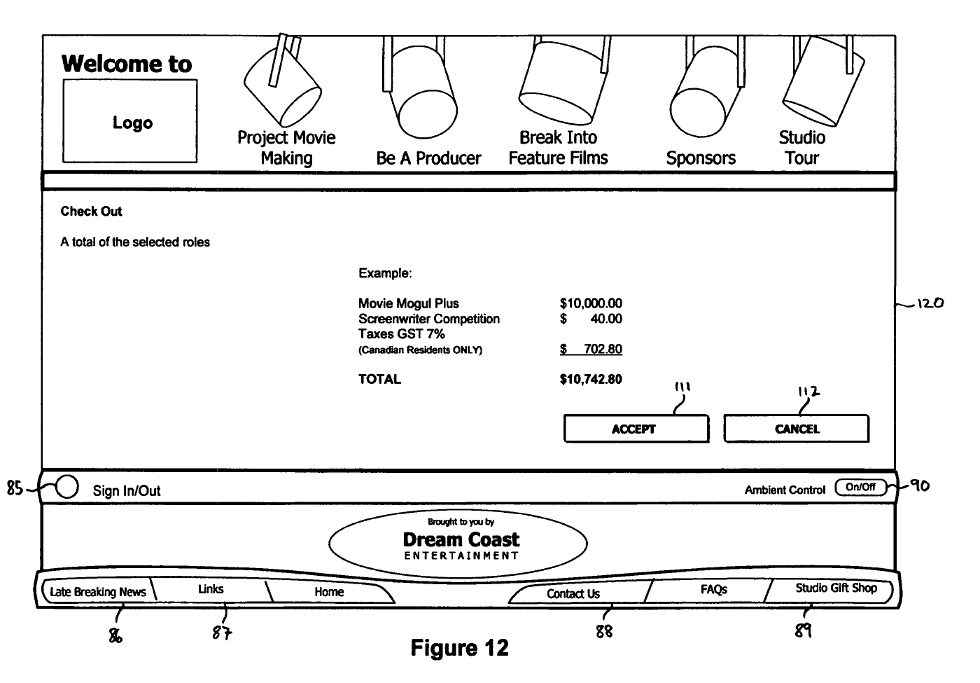

Referring to FIG. 11, IM Producers and contestants are shown the applicable Terms and Conditions or Rules and Regulations, specific for the type of member account chosen by the user. The user then must agree or disagree with the relevant Terms and Conditions or Rules and Regulations by clicking on an agree button 111 or disagree (or cancel) button 112. Selecting the disagree button 112 will result in exit from the registration process and preferably take the user back to the start page 80. Referring to FIG. 12, upon agreeing with the Terms and Conditions and/or the Rules and Regulations by clicking the agree button 111, the user will be presented with check out information 120.

Typically, membership as an IM Producer or as a contestant requires a membership fee. In this instance, the appropriate membership fee for the member type or types chosen is calculated and displayed with the check out information 120. The amount of the membership fee will vary accordingly with varying levels of membership (i.e. IM Producers with varying privileges and membership levels). The user is then again required to confirm or cancel their membership by clicking the appropriate agree button 111 or cancel button 112. Once payment is received and processed, the user's information is added to a portfolio database and the user is accepted as a member and sent an acceptance letter with sign-on and membership information. Sign-on information will include a user name and a password.

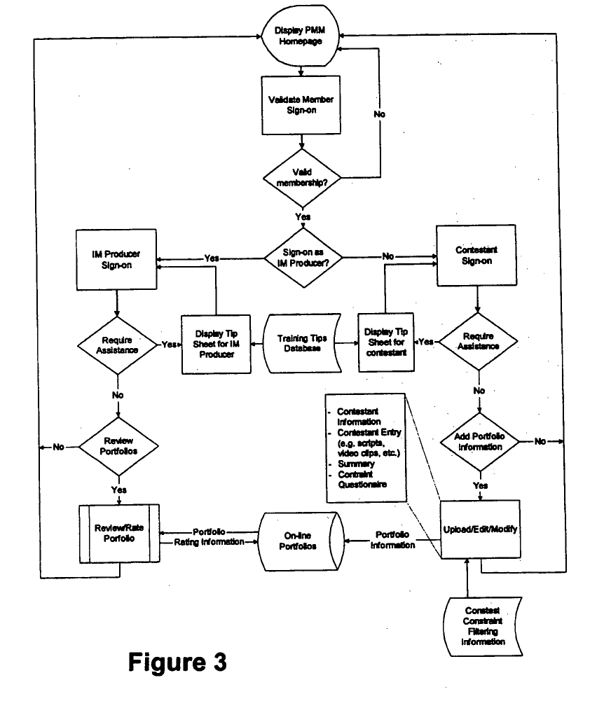

Once a user has been registered as a member, that member may sign on. Referring generally to FIG. 3, a specific method of member sign-on is shown. Referring again to FIG. 8, members sign on by providing their member name in the user name field 83, their password in the password field 84, and clicking the sign in/out button 85 on the start page 80. The user name and password are then verified. If the user name and password are identified as a valid membership, the member is given access to a members' area. The member may be required to indicate whether they are signing on as an IM Producer or as a contestant.

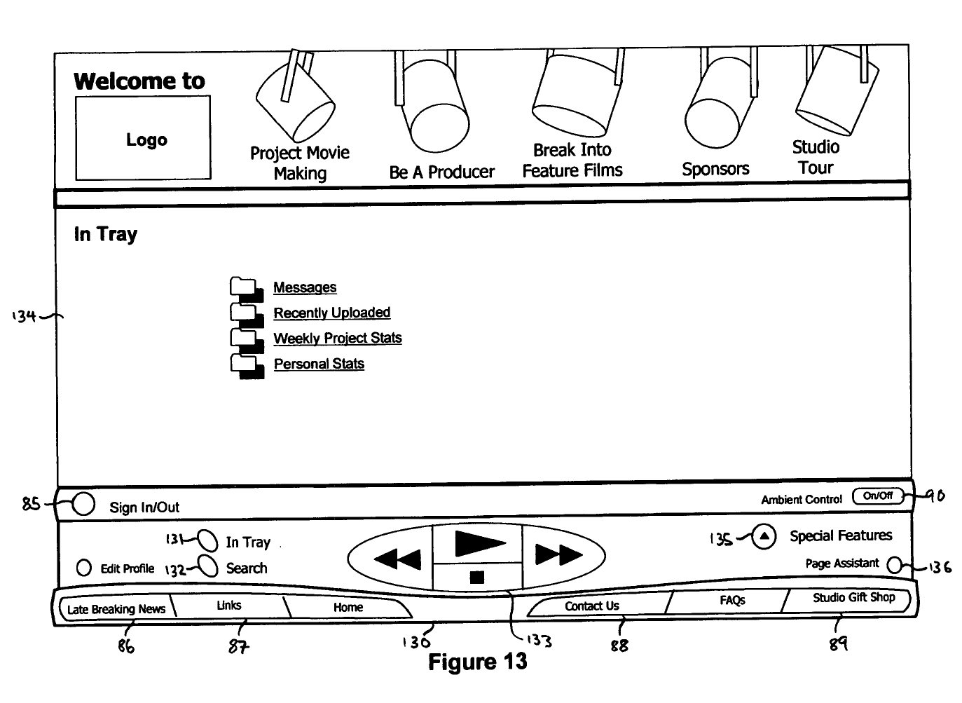

Referring to FIG. 13, a member that has signed on will have access to a customized member window 130. The membership window allows a member to navigate activities and comprises the display 81 and the toolbar 81b. The toolbar 81b of the membership window 130 further comprises an in-tray button 131, a search button 132, a special features button 135, a page assistant button 136 and media control buttons 133. Clicking the in-tray button 131 will display a customized in-tray for that member. The in-tray can include links to information such as, but not limited to, help information, updates, statistics, top screenplays, recently uploaded scripts, and that member's profile. As an additional feature, members may have access to tip sheets and help files that are customized for the type of member account under which they signed-on.

Members have the option to upload, edit or modify portfolio information. Portfolio information for each member will vary depending on whether that member is an IM Producer or a contestant. Generally, only biographical information is included in portfolio information for IM Producers. Contestant portfolio information will include not only biographical information but further information that is relevant to the position for which they are competing. Thus, different contestant positions may have different portfolio requirements. For example, screenwriter contestants may be required to upload a copy of his/her script and director contestants may be required to upload a digitized media clip of his/her work.

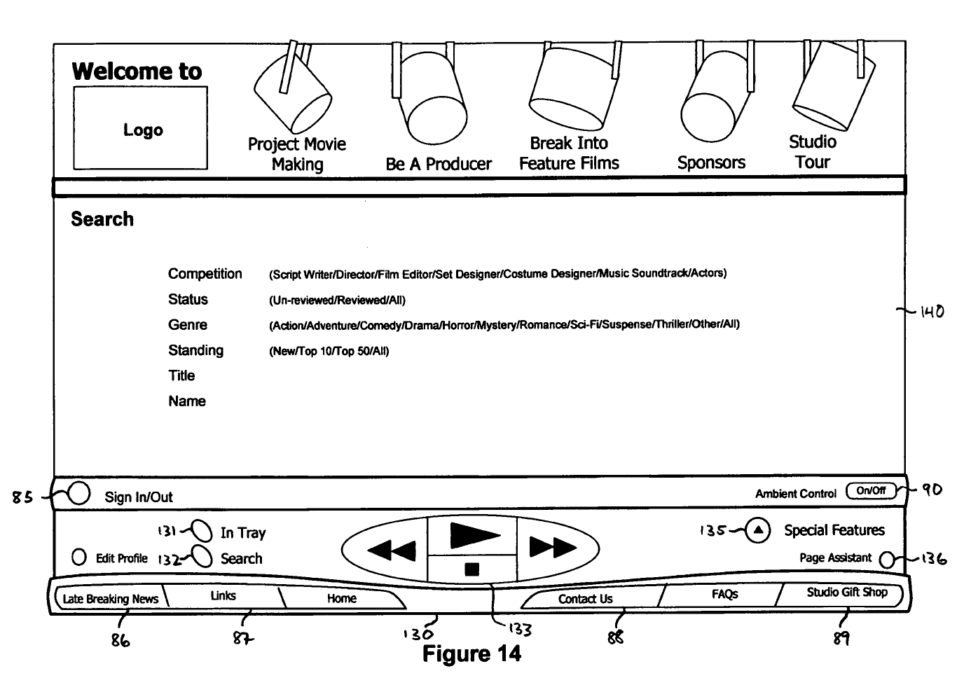

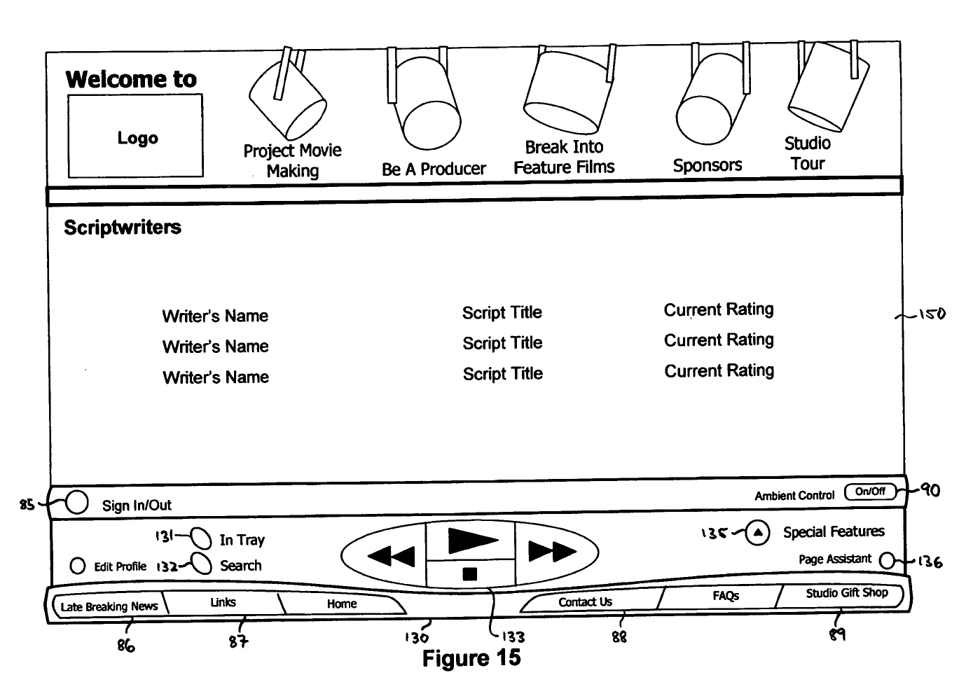

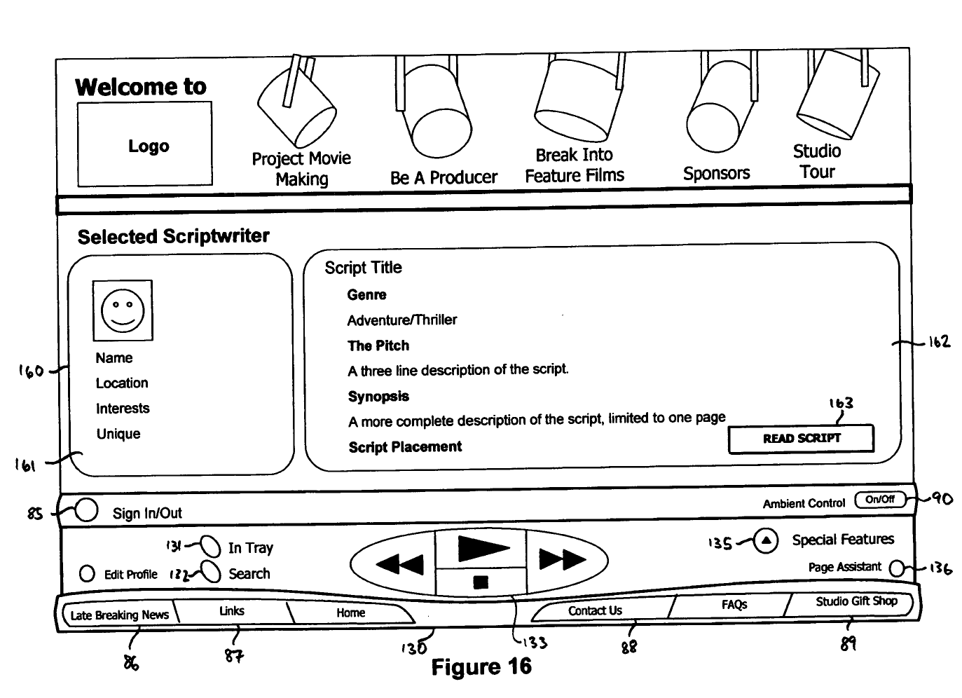

IM Producers may choose to browse and review portfolios. IM Producers begin by choosing to search the portfolio database by clicking on the search button 132. Alternatively, links in the in-tray 134 can lead a user to a list of recently uploaded scripts or portfolios or popular or highly ranked portfolios. A search screen will be displayed once a member has chosen to search the portfolio database. The search screen allows a member to search for scripts or portfolios by entering search terms. Searches may be conducted by any number of parameters, including but not limited to type of portfolio, genre, rating, title, name, or date uploaded. Referring to FIG. 14, a search screen for scripts 140 is shown. Referring to FIG. 15, the search will yield search results which are displayed as a hit list 150. The hit list 150 comprises a list of portfolios that conform to the search criteria. The IM Producer then selects a portfolio to review. Referring to FIG. 16, a portfolio summary 160 of the selected portfolio is displayed, allowing the IM Producer to browse its contents. The portfolio summary 160 comprises an identification field 161, a biography field 162 and a full portfolio button 163. The identification field 161 contains basic information about the member and optionally a photograph. The biography field 162 contains more detailed information about the member. For contestants, the biography field 162 will further comprise information relating to contests in which that member is participating. The option to review the full portfolio contents is accessible from the portfolio summary 160. The IM Producer may then select to review the full portfolio by selecting the full portfolio button 163. The full portfolio button 163 can optionally also display any additional media associated with that portfolio.

For example, referring to FIG. 16, for screenwriter contestants, clicking the read script button 163 will display a copy of the script or effect a download of the script. For directors, viewing the full portfolio may include a media clip that can be downloaded or viewed through the web-based interface and manipulated using the media control buttons 133. For a musician, the full portfolio may contain an audio clip. Generally, the portfolio may include a detailed resume and various types of media relating to that contestant.

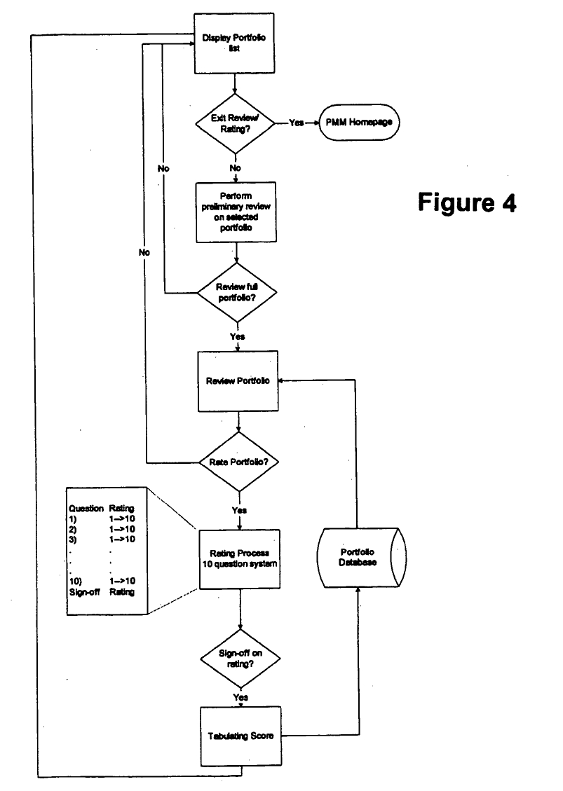

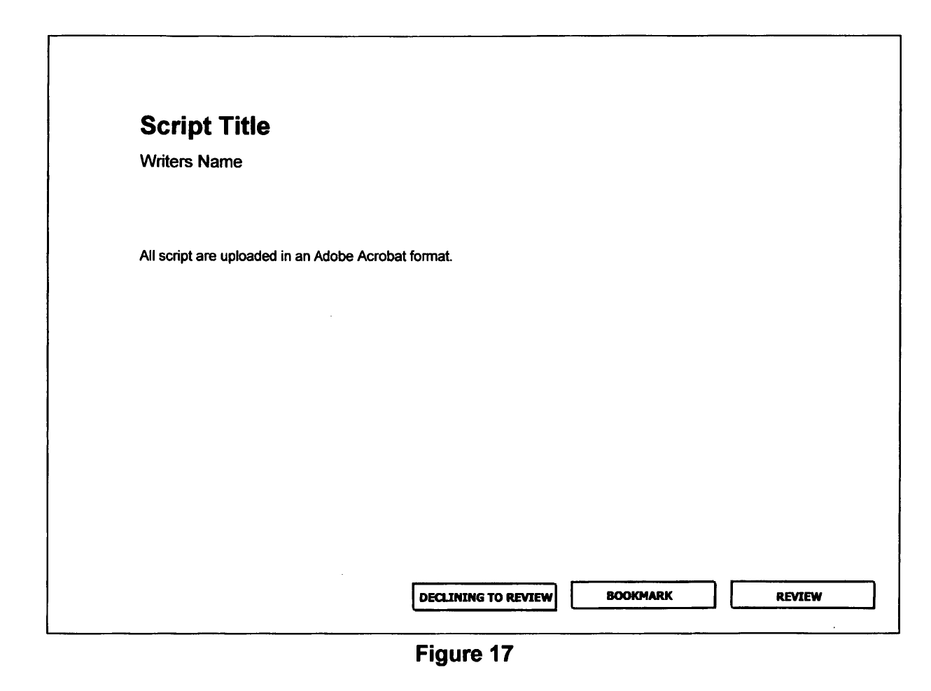

Referring generally to FIG. 4, a method of reviewing and rating portfolios by IM Producers is shown. Referring to FIG. 17, once an IM Producer has finished selecting and reviewing a portfolio, the IM Producer will then have the option to rate or vote for the portfolio. The IM Producer may exit without rating the portfolio, in which case they will be requested to provide reasons. This enables differentiation between an IM Producer abandoning an undesirable script and an IM Producer abstaining from rating or voting. IM Producers also have the option of bookmarking a portfolio so that he/she may return and review the portfolio again or submit a rating. IM Producers may also bookmark a specific place within a script so that he/she may return and finish reading it at a later time.

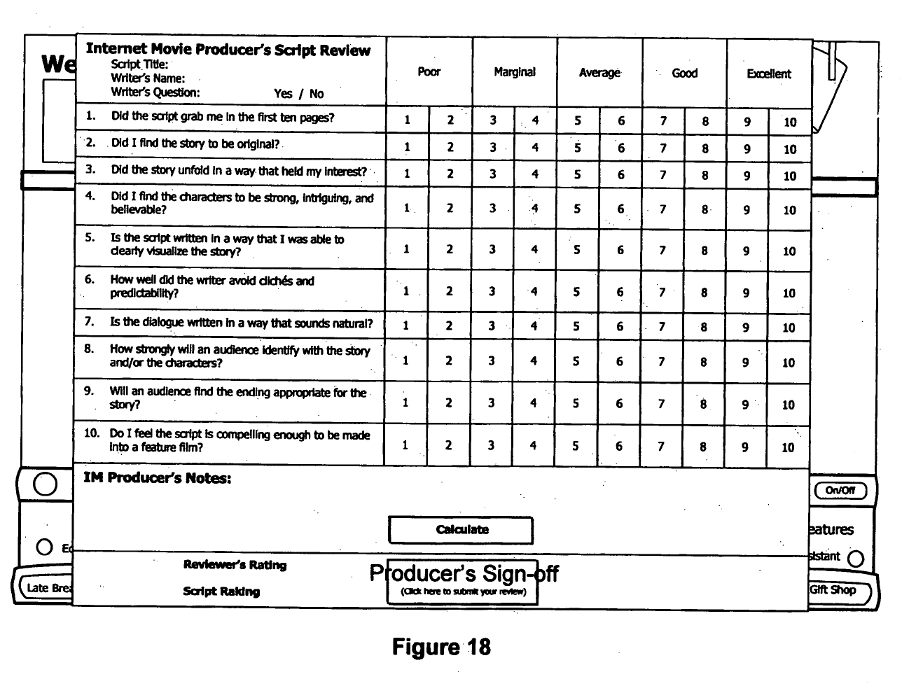

The IM Producer may simply vote for a desired portfolio or, in this preferred embodiment of the invention, the IM Producer rates the portfolio. The rating is preferably effected using a pre-determined rating form with a number of questions that is customized for each category of contestant. One example of a rating form is shown in FIG. 18. Once an IM Producer has rated a particular portfolio, the rating information is tabulated and integrated with the subject portfolio. In some embodiments of the invention where there is more than one class of IM Producers, ratings by different classes of IM Producers may be weighted differently.

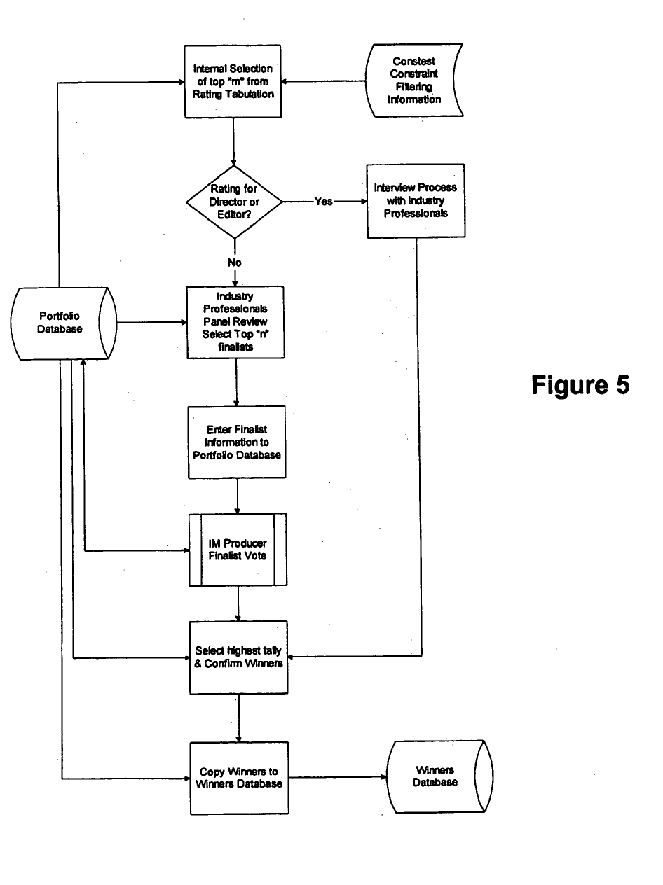

After a predetermined time, corresponding to a contest period for a particular category, has elapsed, one or more winners for each contestant category are determined based on high IM Producer ratings. It is advantageous to calculate high ratings based at least partially on a sum of all scores, rather than just an average score. This ensures that winning portfolios have to also have been reviewed numerous times. In some instances, it is preferable to first shortlist the contestants in a particular category based on the IM Producer ratings and then conduct a further vote of the IM Producers to determine the final one or more winners. Referring to FIG. 5, a preferred method for selecting winners is shown. A shortlist comprising a predetermined number of top contestants in a particular category, based on the IM Producer ratings, is generated. This shortlist is then filtered through a contest constraint filter. The filter will eliminate those contestants who do not fit within the contest guidelines. For example, if the feature film to be produced in accordance with the methods has been budgeted for a predetermined amount of money then scripts costing more than that predetermined amount to produce are not eligible to win. The contest constraint filter will therefore eliminate those contestants that are deemed to not fall within the contest criteria. The shortlist of contestants is then presented to the IM Producers for a final vote where each IM Producer will vote for one (1) winner. The contestant(s) with the highest tally of votes will win and his/her portfolio will be copied to a winner's database and be given the opportunity to participate in the feature film in accordance with that category.

In one embodiment of the invention, a panel of industry experts may review and condense the initial shortlist to a second shorter shortlist. This second shortlist is then presented to the IM Producers for a final vote. Each IM Producer will then submit a final vote for each category. Votes are tallied and a winner for each category is determined.

Further, in some embodiments of the invention, film positions that require a certain amount of technical expertise, such as directors and editors, will be interviewed and a winner selected by a panel of industry experts and not selected by a final vote of the IM Producers.

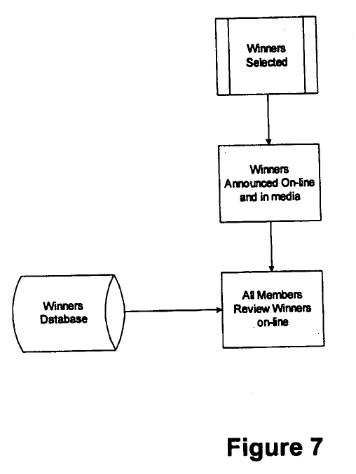

Referring to FIG. 7, a preferred method for conducting the IM Producer final vote is shown. During the final voting period, IM Producers will sign on and will have the option to display the shortlist that has been prepared for final voting. IM Producers may then select portfolios to review. Once the IM Producer has finished reviewing the portfolios, he/she may cast a final vote. The final vote is integrated with each portfolio to be tallied. In some embodiments of the invention where there is more than one class of IM Producers, different classes of IM Producers may hold a different number of votes.

Referring to FIG. 8, once winners are selected based on the highest tallies in each category, the winners are announced, preferably on-line through other widely distributed media, and winner portfolios are available for review by all IM Producers and contestants through the web-based interface.

Once the winners are selected, the feature film will enter production with each contestant winner participating in the film according to his/her relevant category. Although it is preferably for all the winners to have selected before production begins on a film, it will be understood by those skilled in that art that not all winners need be selected before a film begins production. In one preferred embodiment of the invention, winners and IM Producers will receive film credits. Winners and IM-Producers may also receive credits in other media or merchandise resulting from the film such as, but not limited to, DVDs and soundtracks.

In embodiments of the invention that have several classes of different IM Producers, different classes of IM Producers may have differing access to the production of the film. For example, a higher level IM Producer may have access to the set and view the shooting on certain days while a lower level IM Producer may have only web access to the certain media showing the film's production or progress.

In addition to membership (as IM Producers and contestants) being open to the public, the present invention may have additional features to further increase public access to the film. These features include product or people/name placement, within the film, that is open to the public. For example, people placement allows members of the public, such as but not limited to IM Producers, to pay for a certain character to have a name of their choice. Similarly, product placement could include a picture of a loved one in the background of a particular scene. Methods of product and people placement are known and can be performed in conjunction with the present invention. Offer of these additional features can be integrated into the web-based interface.

Another additional feature is to sell or auction off movie memorabilia to the public. Sale or auction of memorabilia may be effected through the web-based interface. Methods of selling goods or auctioning items, particularly online, are known and can be performed in conjunction with the present invention.

The invention has been described with respect to feature films but it will be understood by those skilled in the art that the methods and computer products of the present invention are applicable to other types of media, including, but not limited to, musicals, plays, multi-media, computer games and music.

Although specific embodiments of the invention have been described herein, it will be understood by those skilled in the art that variations may be made thereto without departing from the spirit of the invention or the scope of the appended claims.

1. A method of producing an entertainment product comprising the steps of:
(a) designating a predetermined number of elements, associated with said entertainment product, that are open for application;
(b) registering a plurality of public producers upon receiving public producer applications that are open to the public;
(c) registering a plurality of contestants for each said element upon receiving contestant applications that are open to the public;
(d) registering public producer input regarding contestants;
(e) determining at least one winner for each said element based at least partially on said public producer input; and
(f) producing the entertainment product in accordance with the winners.

2. The method according to claim 1 wherein said entertainment product is a film.

3. The method according to claim 1, wherein said entertainment product is music.

4. The method according to claim 1, wherein said entertainment product is a musical.

5. The method according to claim 1, wherein said entertainment product is a game.

6. The method according to claim 1, wherein said entertainment product is a play.

7. The method according to claim 1, wherein said entertainment product is multi-media.

8. The method according to claim 1 wherein public producers and contestants are listed in the credits of said entertainment product.

9. The method according to claim 1 wherein registering each public producer requires the receipt of a fee from said public producer.

10. The method according to claim 1 wherein registering each contestant requires the receipt of a fee from said contestant.

11. The method according to claim 1, wherein said public producer input is votes.

12. The method according to claim 1, wherein said public producer input is ratings.

13. The method according to claim 1, wherein said public producer input comprises both ratings and votes.

14. The method according to claim 13, wherein ratings determine a shortlist of contestants for at least one category and votes based on said shortlist determine at least one winner.

15. The method according to claim 1, wherein there is an additional step comprising selling or auctioning items used for said producing of said entertainment product.

16. The method according to claim 1, wherein said producing of said entertainment product further comprises placing people, product or proper names within the entertainment upon receiving a fee.

17. A method of determining the identity of elements to be used in producing an entertainment product comprising the steps of:
(a) designating a predetermined number of elements, associated with said entertainment product, that are open for application;
(b) registering a plurality of public producers upon receiving public producer applications that are open to the public;
(c) registering a plurality of contestants for each said element upon receiving contestant applications that are open to the public;
(d) registering public producer input regarding contestants; and
(e) determining at least one winner for each said element based at least partially on said public producer input wherein each said winner of a said element represents the identity of said element.

18-30. (cancelled)

31. A computer program product, comprising a memory having computer-readable code embodied therein for determining the identity of elements to be used in producing an entertainment product comprising:
(a) code means for designating a predetermined number of elements, associated with said entertainment product, that are open for application;
(b) code means for registering a plurality of public producers upon receiving public producer applications that are open to the public;
(c) code means for registering a plurality of contestants for each said element upon receiving contestant applications that are open to the public;
(d) code means for registering public producer input regarding contestants; and
(e) code means for determining at least one winner for each said element based at least partially on said public producer input wherein each said winner of a said element represents the identity of said element.

32-46. (cancelled)
